(19) United States
(12) Patent Application Publication
(10) Pub. No.: US 2011/0133710 A1
(43) Pub. Date: Jun. 9, 2011

(54) Partial Feedback Mechanism in Voltage Regulators to Reduce Output Noise Coupling and DC Voltage Shift at Output

(76) Inventors: Deepak Pancholi, Bangalore (IN); Ekram Bhuiyan, San Jose, CA (US); Steve Chi, Cupertino, CA (US); Naidu Prasad, New Tippasandra (IN); Bhavin Odedara, Kodihalli (IN)

(21) Appl. No.: 12/632,998

(22) Filed: Dec. 8, 2009

(51) Int. Cl. G05F 1/10

(52) U.S. Cl. 323/280

(57) ABSTRACT

Techniques are presented for reducing the DC voltage shift in a voltage regulator, particularly for high and ultra-high speed load switching operation. The regulator includes a power transistor, connected between an input supply voltage and an output node, and an error amplifier, having its output connected to control the gate of the output transistor, a first input connected to receive a reference voltage, and a second input connected to a feedback node. The regulator also includes a first resistance, connected between the feedback node and ground, and also a second resistance, a third resistance, and a first capacitance, where the feedback node is connected to the output node through a combination of the first capacitance in parallel with the second resistance and in series with the third resistance. Consequently, the feedback path from the output node of the regulator uses a partial feedback mechanism, where the capacitance is included to generate a zero in the feedback divider path, but a resistance is placed in series with the capacitance so that at high frequencies the feedback level is still separated from the output level.

### FIELD OF THE INVENTION

This invention pertains generally to the field of voltage regulation circuits and, more particularly, to avoiding DC voltage shift in the output of regulators used in fast load switching applications like for high speed synchronized IO's.

### BACKGROUND

Voltage regulation circuits have many applications in power supply systems to provide a regulated voltage at a predetermined multiple of a reference voltage. In such regulator designs, there is often need for creating zeroes if number of poles are higher than one. In regulators one pole typically occurs due to load capacitance and another pole due to the gate capacitance of the power transistor used to supply the output. A common way of generating zero at the feedback divider path by connecting a capacitor between the output of regulator and feedback node of error amplifier. This provides a zero-pole, enhancing the phase margin, such as described, for example in U.S. Pat. No. 6,518,737. Under such an arrangement, if there is significant noise at the output of the regulator due to fast load switching (like synchronized IO's), this noise couples to the input of the error amplifier (through the feedback zero capacitor) resulting in an undesirable DC shift at the regulator output.

### SUMMARY OF THE INVENTION

According to a general aspect of the invention, a voltage regulator circuit is presented. The regulator includes a power transistor, connected between an input supply voltage and an output node, and an error amplifier, having its output connected to control the gate of the output transistor, a first input connected to receive a reference voltage, and a second input connected to a feedback node. The regulator also includes a first resistance, connected between the feedback node and ground, and also a second resistance, a third resistance, and a first capacitance, where the feedback node is connected to the output node through a combination of the first capacitance in parallel with the second resistance and in series with the third resistance.

Other aspects present a method of operating a voltage regulation circuit including a power transistor and an error amplifier. The method includes receiving at a first input of the error amplifier a reference voltage and controlling the gate of the power transistor with the output error amplifier, where the power transistor is connected between an input supply voltage and an output node of the voltage regulator. The error amplifier receives feedback at a second input, where the feedback is supplied from a node connected to ground through a first resistance and connected to the output node through a combination of a first capacitance in parallel with a second resistance and in series with a third resistance. The regulated output of the circuit is then provided at the output node.

Various aspects, advantages, features and embodiments of the present invention are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 illustrates a classical feedback zero method.

FIG. 2 is a block diagram of one embodiment of a partial feedback zero method.

FIG. 3 is a block diagram of another embodiment of a partial feedback zero method.

FIG. 4 is a table comparing the noise voltage at the feedback node for the embodiments of FIGS. 1 and 2.

FIG. 5 illustrates the effect of DC shift at the regulator output for the arrangement of FIG. 1.

FIG. 6 illustrates the effect of DC shift at the regulator output for the arrangement of FIG. 2.

FIG. 7 illustrates the effect of DC shift at the regulator output for the arrangement of FIG. 3.

### DETAILED DESCRIPTION

The techniques presented in the following discussion allow for a voltage regulator, whose DC voltage shift is reduced, particularly for high and ultra-high speed operation. According to one of the aspects presented here, in an exemplary embodiment the feedback path from the output node includes a capacitance to generate a zero in the feedback divider path, but places a resistance in series with the capacitance so that at high frequencies the feedback level is still separated from the output level.

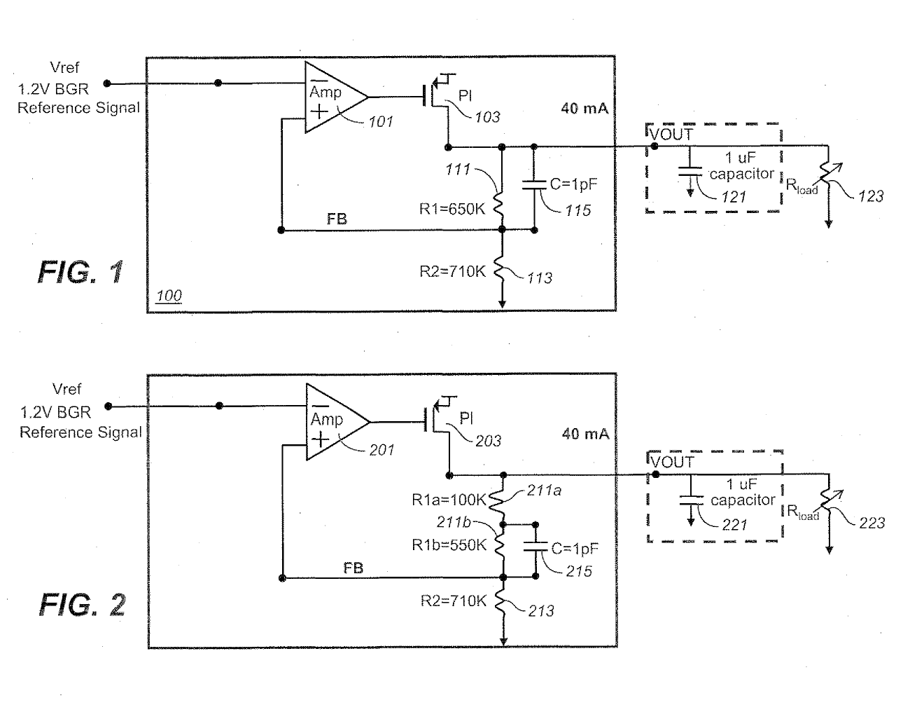

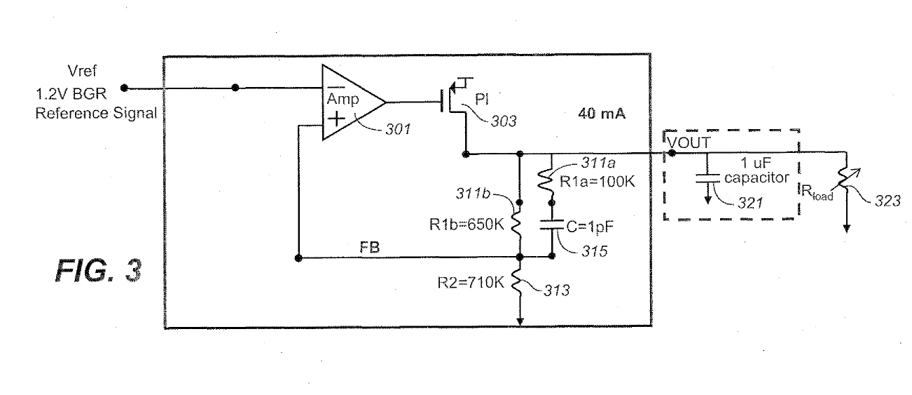

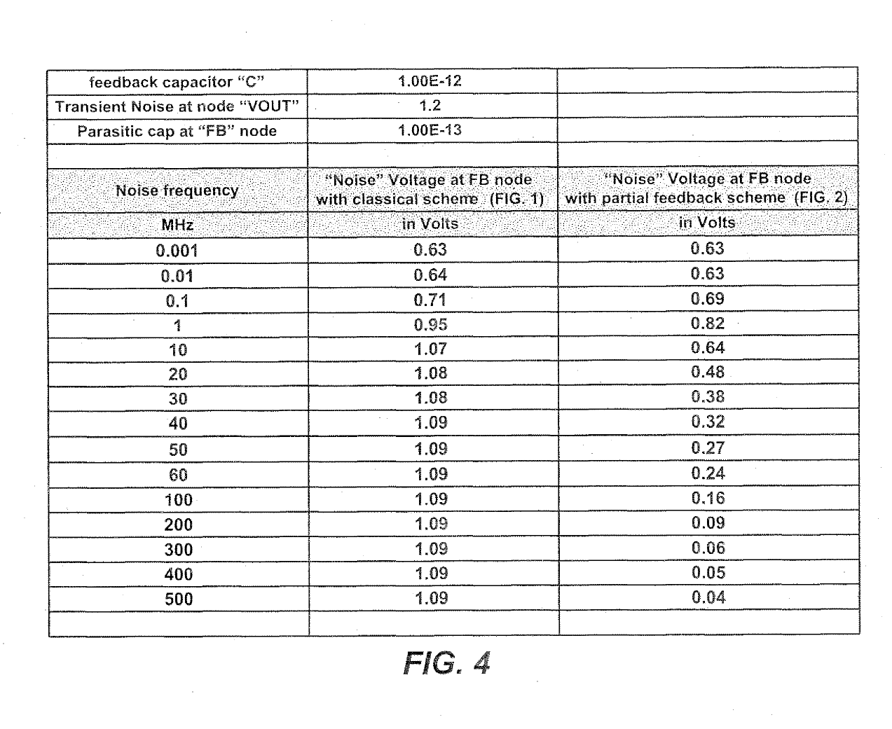

First, the problem of shift in the DC output of a regulator is considered further. As noted in the Background, in regulator design there is often the need for creating zeros if the number of poles is higher than one. In voltage regulators, one pole usually occurs due to the load capacitor and another pole is usually come from the gate capacitance of the output power MOS transistor. A regulator structure with a standard resistor divider zero is shown in FIG. 1. In FIG. 1, and also in FIGS. 2 and 3 discussed further below, only the elements of the regulator structure that enter into the discussion here are represented, with other elements being suppressed to simplify the presentation.

FIG. 1 is a block diagram of a voltage regulator 100 for providing a voltage Vₒᵤₜ at its output to circuit to be supplied, here represented by 123 R_{load}. An external capacitor C_{load} 121, usually having a relatively large capacitance value, is also typically connected to the output of the circuit for filtering purposes. The regulator circuit 100 includes an error amplifier AMP 101 whose output is connected to control the gate of the power transistor, the PMOS P1 103, that is connected between the supply voltage and the output node. The ve input of AMP 101 is connected to receive a reference voltage, such as from a band gap element, and the +ve input receives the feedback. The feedback is taken form a node between the resistances R1 111 and resistance R2 113 connected in series between the output level and ground. As noted above, in this arrangement, a first pole usually occurs due to the load capacitor C_{load} 121 and another pole is usually comes from the gate capacitance of P1 103. The classical way of generating a zero at the feedback divider path by connecting the capacitor C₁ 115 in parallel with R1 111 between the output of regulator and feedback node of error amplifier. (Again, it will be understood that the various other elements that are typically found in regulators as known in the art (buffers, etc.) can be included, both in FIG. 1 and in FIGS. 2 and 3 below; for example, the output of the amplifier may not drive the gate of the power transistor directly, but be connected through, say, another amplifier or a buffer circuit.)

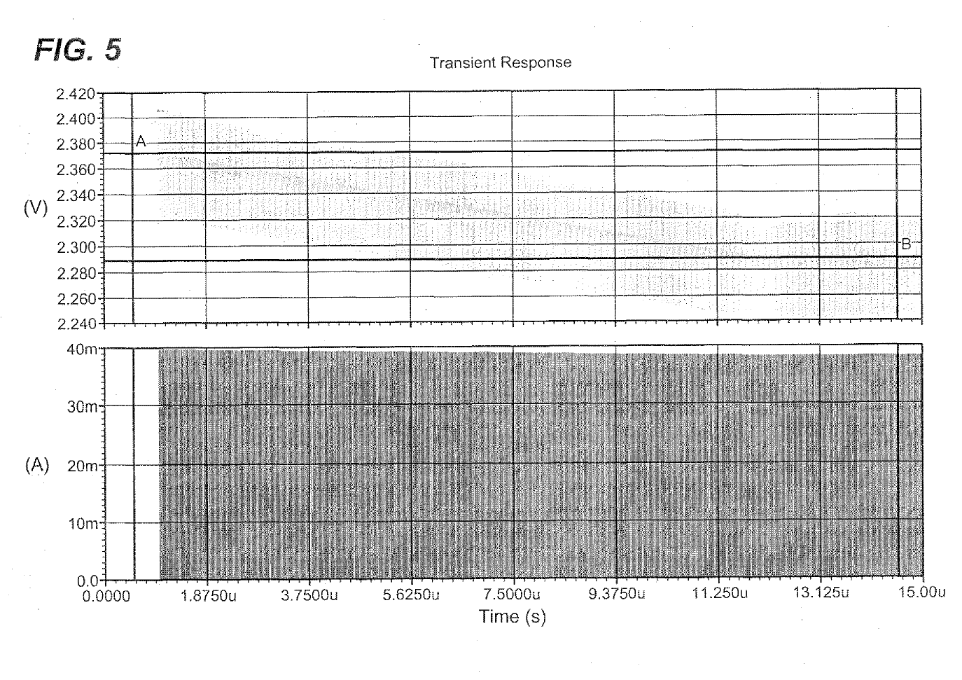

Note that under the arrangement of FIG. 1, the capacitor C₁ 115 directly connects the feedback node to the output of the regulator. Consequently, if there is significant noise at the output of the regulator due to fast load switching, this noise couples to the input of the error amplifier through the feedback zero capacitor C₁ 115, resulting in a DC shift at the regulator output. In FIG. 1, values are shown for R1 111, R2 113, C₁ 115, and C_{load} 121 in a particular embodiment. FIG. 5 illustrates the DC shift at the regulator output for this embodiment.

In FIG. 5, the top and bottom traces respectively show the voltage and current at the output of the regulator circuit of FIG. 1 using the classical feedback mechanism for introducing a zero. As shown in the top trace, there is high frequency noise on the signal, so that the levels at the output node and feedback node are pulled toward each other due to low impedance of the capacitor C₁ 115 at high frequencies. Consequently, the voltage at the output exhibits the shown transient behavior, with the DC shifting down from the level of the line marked A to the level of the line marked B, a shift of ˜83 mV in this example.

One approach to solve this problem is to add a separate pad to the circuit for the feedback path and a large on-chip capacitor at the regulator load. However, even if such a pad is available, such large capacitors are typically expensive to implement on a circuit and are limited by area constraints. According to the techniques presented here, this problem is instead dealt with by maintaining the capacitance in the feedback path, but introducing a resistance in series with the capacitance so that there is no longer a path from the feedback node to the output node with a purely capacitive coupling. This mechanism eliminates the requirement of an additional pad and significantly reduces area requirement of an on-chip decoupling capacitor at the regulator load node.

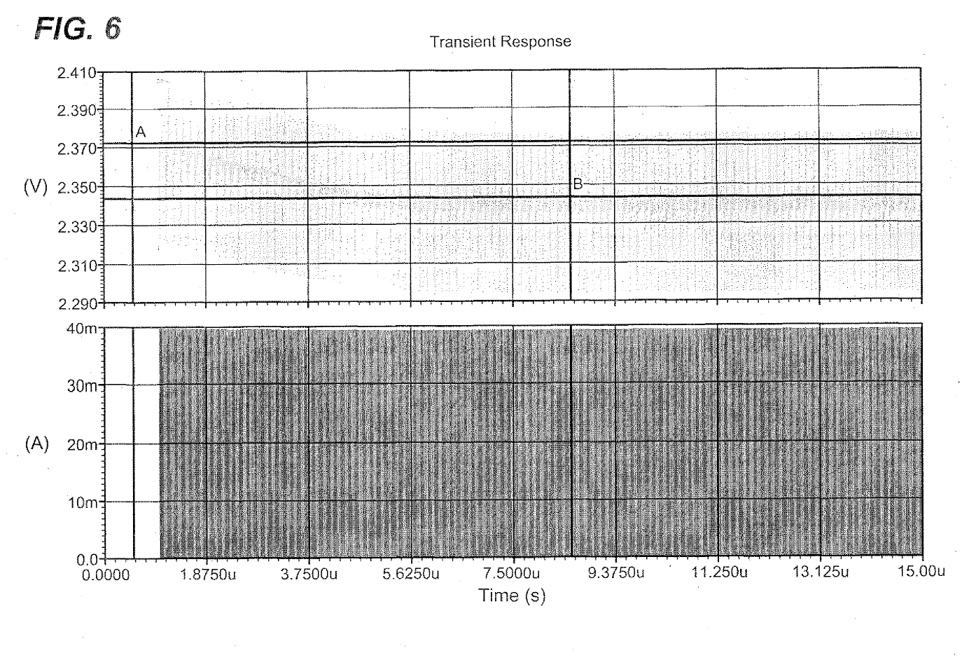

FIGS. 2 and 3 show embodiments where the feedback resistance is divided in a way to generate a kind of feedback, which can be called a partial feedback mechanism. Considering FIG. 2 first, the corresponding elements are numbered the same as in FIG. 1 and those element not explicitly discussed are again suppressed to simplify the discussion. Where FIG. 2 differs in the feedback path. A capacitor C 215 is still connected in parallel with a resistor R1b 211b, but this parallel combination is now connected in series with the resistance R1a 211a. The values of R1a 211a and R1b 211b are chosen so that the value of R1a+R1b is the same as would have chosen for R1 111 in FIG. 1 in order to have a similar structure of poles and zeros for the regulator. Due to this kind of feedback, the capacitor does not see the full output noise and the noise amplitude gets reduced by the resistor R1a 211a, thereby reducing the coupling at the input of error amplifier and the consequent output voltage DC shift. The simulation result is shown in FIG. 6.

The traces of FIG. 6 correspond to those of FIG. 5, but for the circuit of FIG. 2 with the component values shown on there. The transient behavior of the DC level again settles from the line marked A to the one marked B, a DC shift of ˜28 mV, compared with the shift of ˜83 mV found in FIG. 5 for the circuit of FIG. 1.

The table of FIG. 4 compares the noise voltage level at the feedback node for the feedback node FB for the classical arrangement of FIG. 1 with the partial feedback arrangement of FIG. 2. The values of the resistances and capacitances are as shown in FIGS. 1 and 2, where the feedback capacitor has a capacitance of 1 pF, the transient noise at the output node in 1.2V, and there is also a parasitic capacitance (including, for example, the input capacitance of the error amplifier and routing capacitance) at the feedback node FB of 0.1 pF. For both arrangements, for very low noise frequencies, such as 0.001 MHz, the noise voltage at the feedback node is 0.63V. For the classical arrangement of FIG. 1, as the frequency of the noise increases, the feedback node and the output voltage are pulled towards each other. As shown, once the noise frequency gets up to a few MHz, the noise at the feedback node goes up to 1 volt and somewhat above, resulting in the sort of large DC shift shown in FIG. 5. In contrast, for the partial feedback arrangement of FIG. 2, the feedback node stays well separated from output voltage, even at high frequencies.

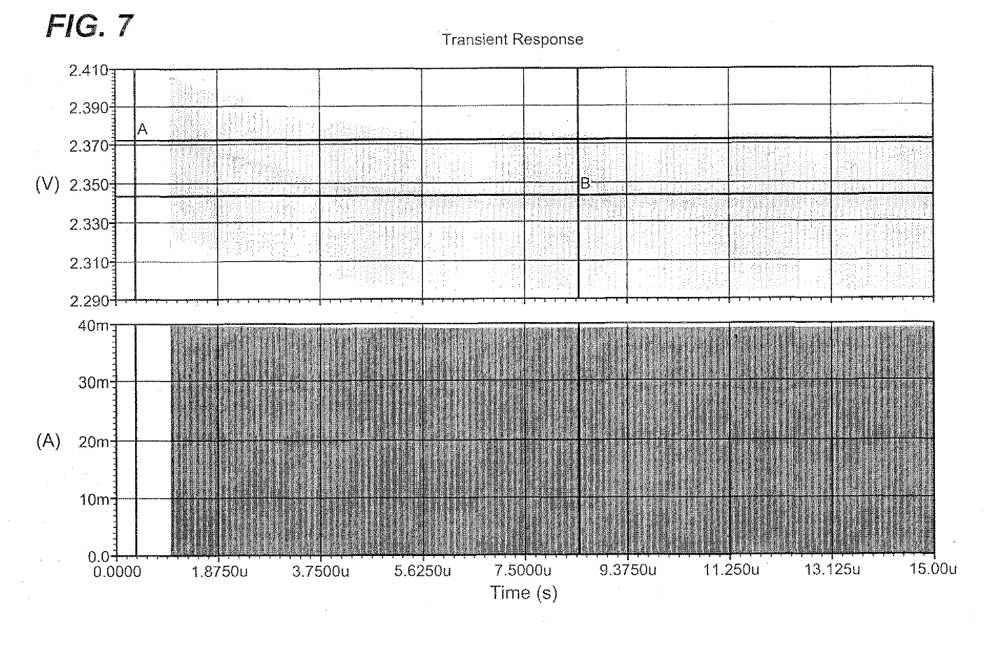

A number of other topologies for the feedback resistor divider can be used which still include a capacitance in parallel with the resistor, in order to introduce the desired zero/pole structure, but also include a resistance in series with the capacitance, so that output and feedback nodes are not coupled by only a pure capacitance. FIG. 3 shows one such variation. The elements are again numbered similarly to FIGS. 1 and 2. In this the feedback loop has a purely resistive leg of resistance R1b 311b connected in parallel with the series combination of R1a 311a and capacitance C 315. FIG. 7 corresponds to FIG. 6, but for the circuit of FIG. 3 with the values shown there, and again has a DC shift of ˜28 mV. It should be noted that various other arrangements are possible, such as flipping the relative positions of the capacitances and resistances of FIGS. 2 and 3 or some sort of combination of these two arrangements.

Values are given for the elements of FIGS. 2 and 3 in exemplary embodiments that are selected to preserve a zero/pole structure similar to that of FIG. 1 with the values shown there. Looking at the feedback divider network for the arrangement of FIG. 1 and taking the ratio of R2 113 over the impedance of R2 111 in parallel with C 115 as a function of frequency, this has a zero at 245 KHz and a pole at 468 KHz. Looking at the corresponding ratio for the circuit of FIG. 2, this has a zero at 290 KHz and a pole at 488 KHz. For the arrangement of FIG. 3, the zero is at 212 KHz and the pole at 362 KHz. Consequently, a zero/pole structure close to that of the classical arrangement is maintained.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

It is claimed:

1. A voltage regulation circuit, comprising:
a power transistor, connected between an input supply voltage and an output node;
an error amplifier, having an output connected to control the gate of the output transistor, a first input connected to receive a reference voltage, and a second input connected to a feedback node;
a first resistance connected between the feedback node and ground; and
a second resistance, a third resistance, and a first capacitance, wherein the feedback node is connected to the output node through a combination of the first capacitance in parallel with the second resistance and in series with the third resistance.

2. The voltage regulation circuit of claim 1, wherein the third resistance is connected in series with the parallel combination of the first capacitance and the second resistance.

3. The voltage regulation circuit of claim 1, wherein the second resistance is connected in parallel with the series combination of the first capacitance and the third resistance.

4. The voltage regulation circuit of claim 1, wherein the reference voltage is provided by a bandgap circuit.

5. The voltage regulation circuit of claim 1, further comprising a second, external capacitance connected to the output.

6. A method of operating a voltage regulation circuit including a power transistor and an error amplifier, the method comprising:
receiving at a first input of the error amplifier a reference voltage;
controlling the gate of the power transistor with the output error amplifier, where the power transistor is connected between an input supply voltage and an output node of the voltage regulator;
receiving feedback at a second input of the error amplifier, where the feedback is supplied from a node connected to ground through a first resistance and connected to the output node through a combination of a first capacitance in parallel with a second resistance and in series with a third resistance; and
providing a regulated output voltage at the output node.

7. The method of claim 6, wherein the third resistance is connected in series with the parallel combination of the first capacitance and the second resistance.

8. The method of claim 6, wherein the second resistance is connected in parallel with the series combination of the first capacitance and the third resistance.

9. The method of claim 6, wherein the reference voltage is received from a bandgap circuit.

10. The method of claim 6, further comprising providing the output voltage at the output node to a second, external capacitance connected to the output node.
